(19) United States
(12) Patent Application Publication
(10) Pub. No.: US 2019/0065413 A1
(43) Pub. Date: Feb. 28, 2019

(54) BURST-SIZED LINKED LIST ELEMENTS FOR A QUEUE

(71) Applicant: Intel Corporation, Santa Clara, CA (US)

(72) Inventor: Anant Raj Gupta, Singapore (SG)

(21) Appl. No.: 15/686,528

(22) Filed: Aug. 25, 2017

(51) Int. Cl. G06F 13/16; G06F 13/28

(52) U.S. Cl. CPC G06F 13/1673; G06F 13/28

(57) ABSTRACT

Methods, apparatus, circuitry, and systems to construct a queue including a plurality of elements are provided. A method includes receiving metadata describing a first buffer; generating a descriptor based on the metadata; and storing the descriptor in an element. The element is configured to store a predetermined number of descriptors and the element includes an amount of memory corresponding to a burst size of a component configured to read the metadata to control access to the first buffer.

### BACKGROUND

Modern routers and switches are expected to be capable of handling multiple streams of data, such as video or voice data. The buffering of large amounts of data by these devices is employed to provide quality of service (QoS) and also to support features such as pause and record in video applications. Further driving the need for the buffering of large amounts of data are modern communication protocols that include regular “silent periods” during which the device will not be transmitting data. The devices thus should be able to store enough data to operate seamlessly even during the silent periods.

### BRIEF DESCRIPTION OF THE DRAWINGS

FIG. 1 illustrates an exemplary system that generates burst-sized elements identifying data stored in buffers in accordance with various aspects described.

FIG. 2 illustrates an exemplary system that stores a linked list of burst-sized elements identifying data stored in buffers in accordance with various aspects described.

FIG. 3 illustrates a flow diagram of an exemplary method for storing a linked list of burst-sized elements identifying data stored in buffers in accordance with various aspects described.

### DETAILED DESCRIPTION

Buffering systems store received data (e.g., packets) in memory for later use. When a stream of data is received, portions of the stream are stored as sets of data in buffers that are allocated in an asymmetric manner. Buffering systems also generate metadata that records information used to retrieve the data from the buffers. Descriptors containing the metadata for each buffer are typically stored in a queue and the access of the buffers is controlled based on the descriptors in the queue. In this manner, the order in which the buffers should be accessed to maintain the proper order of the data stream is preserved. A queue is maintained for each data stream, for example, one queue for each data stream on a router where multiple users are streaming video.

Buffering systems will be described herein in the context of a router or switch and, specifically, network interface controllers (NIC) that include “on-chip” circuitry and “on-chip” memory such as static random access memory (SRAM) as well as “off-chip” memory such as dynamic random access memory (DRAM). The NIC includes an on-chip media access controller that reads descriptors from on-chip memory or off-chip memory for dynamically growing queues to control the reading of data stored in buffers in off-chip memory (.e.g., DRAM). It should be noted that the linked-list of burst-sized elements described herein may be applied in any buffering system that handles large quantities of data. Further, components and memory described as being off-chip herein may be located on-chip in some embodiments, and vice versa.

Buffers are often implemented in off-chip memory, such as dynamic random access memory (DRAM). In the past, the associated queues were stored in on-chip memory to expedite the reading of the buffers by the media access controller. As the quantity of data in buffers and thus the size of the queue increases, it may become more desirable to store the queues in off-chip static random access memory (e.g., DRAM) as well. However, accessing off-chip memory incurs additional delay in transferring a next element in the queue to on-chip memory for memory access control.

Described herein are systems and methods in which descriptors are stored in “burst-sized” elements that may be stored in a queue. For the purposes of this description, burst-size means an amount of data that can be received by a memory access controller, or other device accessing the queue, without going through all the steps required to transmit each piece of data to the memory access controller in a separate transaction. The usual reason for the memory access controller having a burst mode capability, or using burst mode, is to increase data throughput. The steps left out while performing a burst mode transaction may include waiting for input from another device; waiting for an internal process to terminate before continuing the transfer of data; or transmitting information which would be required for a complete transaction, but which is inherent in the use of burst mode.

The “burst-sized” elements described herein have a predetermined size that is chosen to be as close as possible to the burst size of the memory access controller (or any other device transferring the elements into memory) without exceeding the memory access controller's burst size. Ideally, the burst-sized element will contain exactly the same number of bytes as in the burst size. However, the burst-sized element may be slightly smaller than the actual burst size for some reasons, such as the ratio between the amount of memory consumed by the descriptors and the burst size not being an integer multiple of the descriptor size, device capabilities, margin of error, and so on. Thus, when an element is described as being burst-sized, or having a size corresponding to the burst size, the element may have a size that has been maximized to approach the burst size but may be slightly smaller than the burst size. The number of descriptors in a burst-sized element is affected by the amount of memory that is reserved to store a pointer to a next element in the queue, as will be described in more detail below.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” “circuitry” and the like are intended to refer to a computer-related entity, hardware, software (e.g., in execution), and/or firmware. For example, a circuitry can be a circuit, a processor, a process running on a processor, a controller, an object, an executable, a program, a storage device, and/or a computer with a processing device.

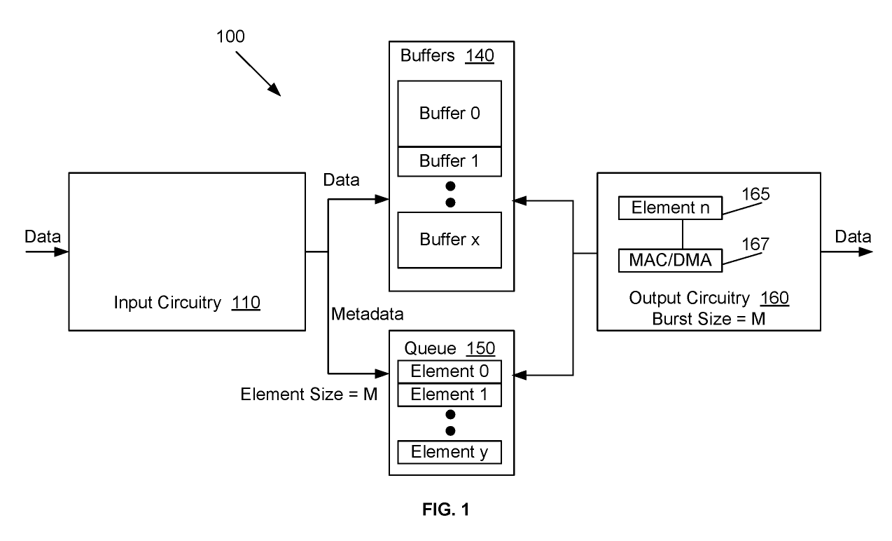

FIG. 1 illustrates a system 100 that buffers a stream of data. Input circuitry 110 receives the stream of data and stores different portions or sets of the data in buffers 140. The input circuitry 110 also generates a descriptor describing metadata about each buffer and stores sets of descriptors in elements in a queue 150. Both the buffers 140 and the queue 150 are in off-chip memory, meaning that they are in memory media that is not located on the same chip as a media access controller (MAC) or Direct Memory Access (DMA) circuitry 167 in the output circuitry 160. In one example, the buffers 140 are in DRAM and the queue 150 is also in DRAM.

To retrieve the data and reconstruct the input data stream, the output circuitry 160 transfers a “next” element from the queue 150 into on-chip memory 165 (e.g., SRAM). The MAC/DMA 167 retrieves the data from the buffers 140 identified by the descriptors in the element stored in the on-chip memory 165 and outputs the data to a requesting component. The MAC/DMA 167 has an associated burst size, which is the amount of memory that the memory access controller can access from the queue in a single burst. The burst size of the media access controller is a parameter that is set based on the particular application and in view of such factors as the capabilities of the components consuming the data stream. As will be described in more detail below, each element in the queue includes a plurality of descriptors (as many as possible) and consumes an amount of memory that approximates the burst size. Thus, the each element is “burst-sized.”

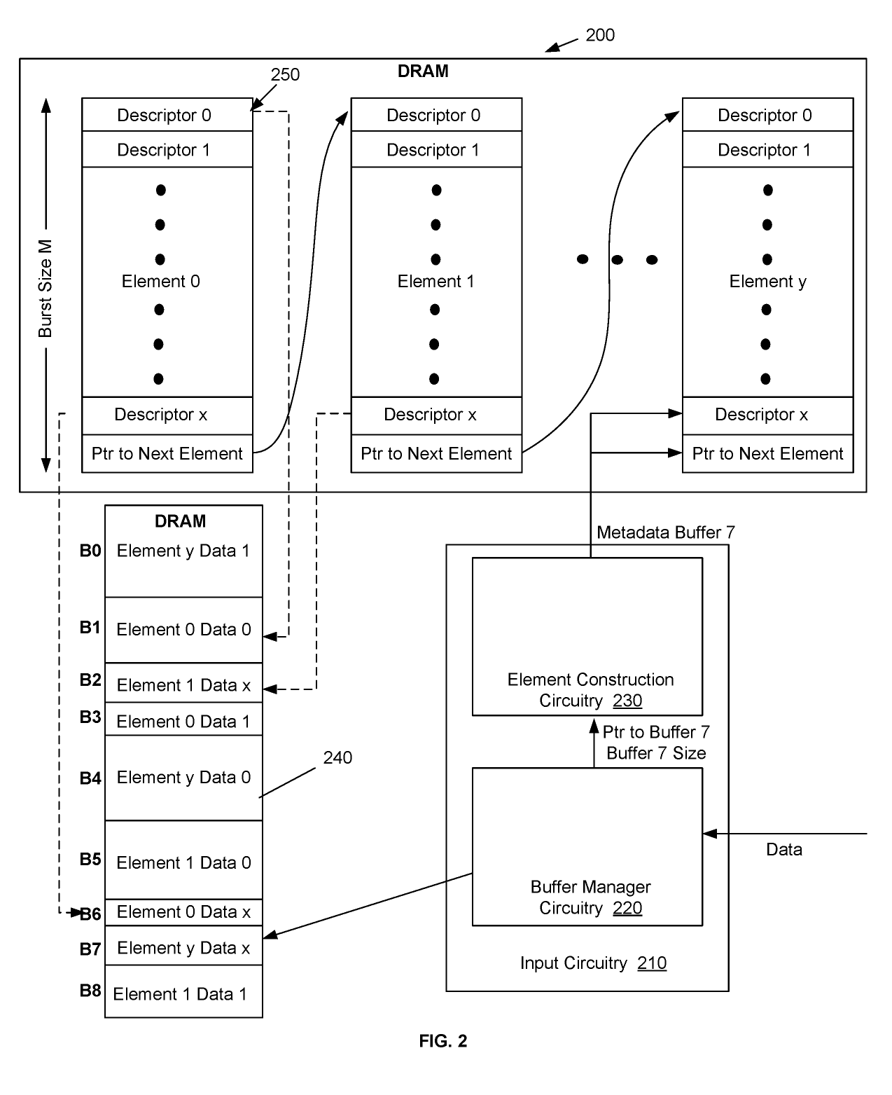

FIG. 2 illustrates an example of a buffering system 200 that includes buffers 240 in DRAM and also a queue 250 in DRAM. Nine buffers are (B0-B8) are shown, however, the number of buffers will change continuously as data is buffered and removed from the buffers during operation. The buffering system includes input circuitry 210 that receives a stream of data. The input circuitry 210 includes buffer manager circuitry 220 that allocates DRAM memory for buffers and store portions or sets of the data stream in the buffers. Each buffer includes a set of contiguous memory addresses. In the example illustrated in FIG. 2, the buffer manager circuitry 220 stores a portion of the data in buffer 7. The buffers do not have a set size.

The buffer manager circuitry 220 generates metadata describing each buffer. For example, the metadata may include a pointer to the starting memory location of a buffer (e.g., the address of buffer B7 in the example) and also the size or length (e.g., in number of bytes or memory addresses) of the buffer. The dashed line arrows in FIG. 2 identify the relationship between a few example descriptors in the elements and the buffers they describe. For example, descriptor 0 in element 0 describes buffer B1, which includes the first portion of data in a buffered data stream that should be transferred out of buffer next. Element construction circuitry 230 generates a descriptor that includes the metadata and stores the descriptor in an element in the queue 250. In the example, the element construction circuitry is storing a “final” descriptor x in element y.

The queue 250 is a linked list of y+1 burst-sized elements in which each element includes x descriptors and also a pointer to a next element in the queue. In one example, each element includes a number of contiguous memory locations in DRAM. The number x is determined based on (e.g., by reading from memory or register) the burst size of the MAC/DMA 167 or other component transferring the element out of DRAM and also an amount of memory used to store the pointer to the next element. Thus the number x is maximized such that the sum of i) an amount of memory p consumed by a pointer to an element and ii) x times the amount of memory d consumed by a descriptor is as close to the burst size as possible without going over. In one example, if the burst size is m, m−(p+xd)<d. Further, if the burst size changes, a new number x may be determined and the element size can thus be dynamically adapted to adjust to the new burst size.

Element 0 is a “head” of the queue and will be the next element transferred into on-chip memory while element y is the “tail” of the queue. Once the element at the tail of the queue (e.g., element y) contains x elements, the element construction circuitry 230 determines a memory location in DRAM where a next element will begin and stores a pointer to that memory location in element y. Thus, the queue can grow dynamically and is limited only by the size of the DRAM (which can be quite large in modern systems). As elements are transferred into on-chip memory, the DRAM that stored them may be re-allocated for new elements. There is no direct relationship between the amount of memory stored in the buffers 240 and the amount of memory consumed by the queue 250. It can be seen that the buffering system 200 provides high performance in transferring large numbers of descriptors out of the queue in a single burst without being limited to any preset queue size.

The buffering system 200 will likely include multiple queues, one for each incoming or outgoing data stream. By allowing each queue to grow dynamically as needed, it is not necessary to pre-allocate memory to each queue, which reduces the amount of DRAM needed to implement the buffering system.

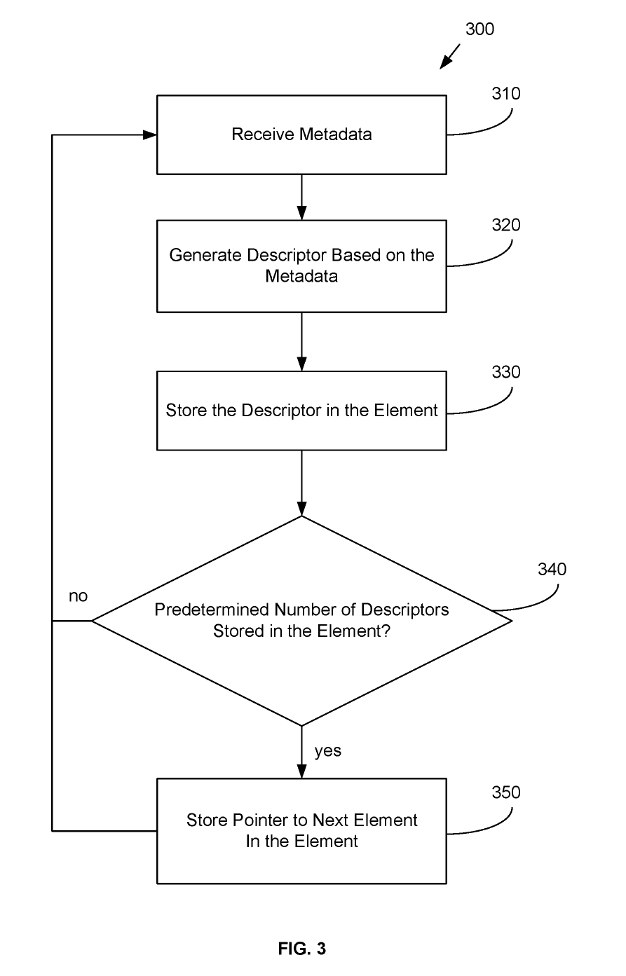

FIG. 3 illustrates a flow diagram outlining one embodiment of a method 300 to construct a linked list of burst-sized elements for a queue. The method 300 may be performed, for example, by the input circuitry 110 of FIG. 1 and/or the element construction circuitry 230 of FIG. 2. The method includes, at 310, receiving metadata describing a first buffer. At 320, a descriptor is generated based on the first metadata and at 330 the descriptor is stored in an element. The element is configured to store a predetermined number of descriptors. The element includes an amount of memory corresponding to a burst size of a component configured to read the metadata to control access to data in the first buffer.

At 340 a determination is made as to whether the predetermined number of descriptors have been stored in the element. If not, the method returns to 310 and a next descriptor for a next buffer is generated and stored. When the predetermined number of descriptors has been stored in the element, the method includes, at 350, storing, in the element, a pointer to a next element, wherein the next element also includes comprises an amount of memory corresponding to the burst size of the component.

It can be seen from the foregoing description using a linked list of burst-sized elements in a buffering or queuing system allows for fast burst access to the descriptors in the queue and while providing dynamic queue sizing.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

Examples herein can include subject matter such as a method, means for performing acts or blocks of the method, at least one machine-readable medium including executable instructions that, when performed by a machine (e.g., a processor with memory or the like) cause the machine to perform acts of the method or of an apparatus or system for concurrent communication using multiple communication technologies according to embodiments and examples described.

Example 1 is a method, including: receiving metadata describing a first buffer; generating a descriptor based on the metadata; and storing the descriptor in an element. The element is configured to store a predetermined number of descriptors and includes an amount of memory corresponding to a burst size of a component configured to read the metadata to control access to the first buffer.

Example 2 includes the subject matter of example 1, including or omitting optional elements, further including, in response to the predetermined number of descriptors being stored in the element: storing, in the element, a pointer to a next element, wherein the next element includes an amount of memory corresponding to the burst size of the component.

Example 3 includes the subject matter of example 2, including or omitting optional elements, wherein a memory capacity to store the predetermined number of descriptors combined with a memory capacity to store the pointer is substantially equal to the burst size.

Example 4 includes the subject matter of examples 1-3, including or omitting optional elements, wherein the descriptor includes a memory location of the buffer.

Example 5 includes the subject matter of examples 1-3, including or omitting optional elements, wherein the descriptor includes a size of the buffer.

Example 6 includes the subject matter of examples 1-3, including or omitting optional elements, further including: receiving second metadata describing a second buffer; generating a second descriptor based on the second metadata; and storing the second descriptor in the element.

Example 7 includes the subject matter of example 6, including or omitting optional elements, wherein a size of the first buffer is not equal to a size of the second buffer.

Example 8 includes the subject matter of examples 1-3, including or omitting optional elements, further including: determining the burst size of the component; and selecting the predetermined number of descriptors based on the determined burst size.

Example 9 includes the subject matter of example 8, including or omitting optional elements, further including: determining that a burst size of the component has changed to a second burst size; and selecting a new predetermined number of descriptors based on the second burst size.

Example 10 is input circuitry configured to construct a queue including a plurality of elements, including element construction circuitry. The element construction circuitry is configured to: receive metadata describing a first buffer; generate a descriptor based on the metadata; and store the descriptor in an element. The element is configured to store a predetermined number of descriptors and includes an amount of memory corresponding to a burst size of a component configured to read the metadata to control access to the first buffer.

Example 11 includes the subject matter of example 10, including or omitting optional elements, wherein the element construction circuitry is further configured to: determine that the predetermined number of descriptors has been stored in the element; and store, in the element, a pointer to a next element, wherein the next element includes an amount of memory corresponding to the burst size of the component.

Example 12 includes the subject matter of example 11, including or omitting optional elements, wherein a memory capacity to store the predetermined number of descriptors combined with a memory capacity to store the pointer is substantially equal to the burst size.

Example 13 includes the subject matter of examples 10-12, including or omitting optional elements, wherein the descriptor includes a memory location of the buffer.

Example 14 includes the subject matter of examples 10-12, including or omitting optional elements, wherein the descriptor includes a size of the buffer.

Example 15 includes the subject matter of examples 10-12, including or omitting optional elements,wherein the element construction circuitry is further configured to: receive second metadata describing a second buffer; generate a second descriptor based on the second metadata; and store the second descriptor in the element.

Example 16 includes the subject matter of examples 10-12, including or omitting optional elements, wherein a size of the first buffer is not equal to a size of the second buffer.

Example 17 includes the subject matter of examples 10-12, including or omitting optional elements, wherein the element construction circuitry is further configured to: determine the burst size of the component; and select the predetermined number of descriptors based on the determined burst size.

Example 18 includes the subject matter of example 17, including or omitting optional elements, wherein the element construction circuitry is further configured to: determine that a burst size of the component has changed to a second burst size; and select a new predetermined number of descriptors based on the second burst size.

Example 19 is a buffering system, including input circuitry and output circuitry. The input circuitry is configured to: receive metadata describing a buffer stored in a first memory; generate a descriptor based on the metadata; and store the descriptor in an element in a queue stored in a second memory, wherein the element is configured to store a predetermined number of descriptors, and wherein the element includes an amount of memory corresponding to a burst size of a component configured to read the metadata to control access to the buffer. The output circuitry is configured to: read a pointer to a next element in an element stored in a third memory; transfer the next element in the queue into a third memory in a single burst. The output circuitry is configured to, until all descriptors have been read: read a next descriptor in the next element; and retrieve data from the first memory based on the descriptor. When all descriptors in the next element have been read, the output circuitry is configured to read a pointer in the next element that points to a subsequent next element in the queue.

Example 20 includes the subject matter of example 19, including or omitting optional elements, wherein the first memory includes dynamic random access memory (DRAM).

Example 21 includes the subject matter of example 19, including or omitting optional elements, wherein the second memory includes dynamic random access memory (DRAM).

Example 22 includes the subject matter of example 19, including or omitting optional elements, wherein the third memory includes static random access memory (SRAM).

Example 23 is an apparatus, including: means for receiving metadata describing a first buffer; means for generating a descriptor based on the metadata; and means for storing the descriptor in an element. The element is configured to store a predetermined number of descriptors and the element includes an amount of memory corresponding to a burst size of a component configured to read the metadata to control access to the first buffer.

Example 24 includes the subject matter of example 23, including or omitting optional elements, further including: means for storing, in the element, a pointer to a next element, in response to the predetermined number of descriptors being stored in the element, wherein the next element includes an amount of memory corresponding to the burst size of the component.

It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may include one or more modules operable to perform one or more of the acts and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Further, the acts and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the acts and/or actions of a method or algorithm may reside as one or any combination or set of codes and/or instructions on a machine-readable medium and/or computer readable medium, which may be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving metadata describing a first buffer;
generating a descriptor based on the metadata; and
storing the descriptor in an element, wherein the element is configured to store a predetermined number of descriptors, and wherein the element comprises an amount of memory corresponding to a burst size of a component configured to read the metadata to control access to the first buffer.

2. The method of claim 1, further comprising, in response to the predetermined number of descriptors being stored in the element:
storing, in the element, a pointer to a next element, wherein the next element comprises an amount of memory corresponding to the burst size of the component.

3. The method of claim 2, wherein a memory capacity to store the predetermined number of descriptors combined with a memory capacity to store the pointer is substantially equal to the burst size.

4. The method of claim 1 wherein the descriptor comprises a memory location of the buffer.

5. The method of claim 1, wherein the descriptor comprises a size of the buffer.

6. The method of claim 1, further comprising:
receiving second metadata describing a second buffer;
generating a second descriptor based on the second metadata; and
storing the second descriptor in the element.

7. The method of claim 6, wherein a size of the first buffer is not equal to a size of the second buffer.

8. The method of claim 1, further comprising:
determining the burst size of the component; and
selecting the predetermined number of descriptors based on the determined burst size.

9. The method of claim 8, further comprising:
determining that a burst size of the component has changed to a second burst size; and
selecting a new predetermined number of descriptors based on the second burst size.

10. Input circuitry configured to construct a queue comprising a plurality of elements, comprising:
element construction circuitry configured to:
receive metadata describing a first buffer;
generate a descriptor based on the metadata; and
store the descriptor in an element, wherein the element is configured to store a predetermined number of descriptors, and wherein the element comprises an amount of memory corresponding to a burst size of a component configured to read the metadata to control access to the first buffer.

11. The input circuitry of claim 10, wherein the element construction circuitry is further configured to:
determine that the predetermined number of descriptors has been stored in the element; and
store, in the element, a pointer to a next element, wherein the next element comprises an amount of memory corresponding to the burst size of the component.

12. The input circuitry of claim 11, wherein a memory capacity to store the predetermined number of descriptors combined with a memory capacity to store the pointer is substantially equal to the burst size.

13. The input circuitry of claim 10, wherein the descriptor comprises a memory location of the buffer.

14. The input circuitry of claim 10, wherein the descriptor comprises a size of the buffer.

15. The input circuitry of claim 10, wherein the element construction circuitry is further configured to:
receive second metadata describing a second buffer;
generate a second descriptor based on the second metadata; and
store the second descriptor in the element.

16. The input circuitry of claim 15, wherein a size of the first buffer is not equal to a size of the second buffer.

17. The input circuitry of claim 10, wherein the element construction circuitry is further configured to:
determine the burst size of the component; and
select the predetermined number of descriptors based on the determined burst size.

18. The input circuitry of claim 17, wherein the element construction circuitry is further configured to:
determine that a burst size of the component has changed to a second burst size; and
select a new predetermined number of descriptors based on the second burst size.

19. A buffering system, comprising:
input circuitry configured to:
receive metadata describing a buffer stored in a first memory;
generate a descriptor based on the metadata; and
store the descriptor in an element in a queue stored in a second memory,
wherein the element is configured to store a predetermined number of descriptors, and wherein the element comprises an amount of memory corresponding to a burst size of a component configured to read the metadata to control access to the buffer; and
output circuitry configured to:
read a pointer to a next element in an element stored in a third memory;
transfer the next element in the queue into a third memory in a single burst;
until all descriptors have been read:
read a next descriptor in the next element; and
retrieve data from the first memory based on the descriptor; and
when all descriptors in the next element have been read, read a pointer in the next element that points to a subsequent next element in the queue.

20. The buffering system of claim 19, wherein the first memory comprises dynamic random access memory (DRAM).

21. The buffering system of claim 19, wherein the second memory comprises dynamic random access memory (DRAM).

22. The buffering system of claim 19, wherein the third memory comprises static random access memory (SRAM).
